(19) United States
(12) Patent Application Publication
(10) Pub. No.: US 2014/0186134 A1
(43) Pub. Date: Jul. 3, 2014

(54) Self-Locking Nut Assembly

(71) Applicant: Chen-Mao Lin, (US)

(72) Inventor: Chen-Mao Lin, (US)

(21) Appl. No.: 13/733,357

(22) Filed: Jan. 3, 2013

(51) Int. Cl. F16B 39/24

(52) U.S. Cl. CPC F16B 39/24
USPC 411/204

(57) ABSTRACT

A self-locking nut assembly includes a nut, and a washer connected with the nut. The nut has a screw bore and a protruding conical ring. The washer has a central portion provided with a conical hole which includes a limit section and an annular tapered section. The conical ring is extended through the conical hole. The conical ring of the nut has a distal portion provided with an annular opening which is enlarged and expanded outward to form a protruding flange. The protruding flange is limited by the limit section of the conical hole. Thus, a determined clearance is defined between the conical ring of the nut and the conical hole of the washer, so that the nut and the washer have determined axial and radial gaps, and the washer can be rotated freely.

### BACKGROUND OF THE INVENTION

1. Field of the Invention

The present invention relates to a nut and washer assembly and, more particularly, to a self-locking nut assembly.

2. Description of the Related Art

A conventional self-locking nut assembly in accordance with the prior art shown in FIG. 1 comprises a nut 10, and a washer 11 connected with the nut 10. The nut 10 has a screw bore 101. The screw bore 101 of the nut 10 has a periphery provided with an annular portion 102. The annular portion 102 of the nut 10 has a distal end provided with an annular opening 103. The washer 11 has a central hole 111 which is greater than the annular portion 102 of the nut 10. The central hole 111 of the washer 11 has a periphery provided with an annular groove 112 greater than the central hole 111. A clearance 13 is defined between the annular opening 103 of the nut 10, and the annular groove 112 and the central hole 111 of the washer 11. The annular portion 102 of the nut 10 is initially extended through the central hole 111 of the washer 11. Then, a plunger of a stamping die is inserted into the annular opening 103 of the nut 10 to expand and enlarge the annular opening 103 of the nut 10 so that the annular opening 103 of the nut 10 has a size grater than the diameter of the central hole 111 of the washer 11. Thus, the washer 11 is limited by the annular opening 103 of the nut 10 so that the washer 11 is combined with the nut 10 and will not be detached from each other. However, the annular opening 103 of the nut 10 is expanded outward so that the clearance 13 between the annular opening 103 of the nut 10, and the annular groove 112 and the central hole 111 of the washer 11 is shortened to limit the radial movable space of the washer 11. In addition, the annular opening 103 of the nut 10 is easy to press the annular groove 112 of the washer 11, so that the washer 11 is locked and cannot be rotated. Further, when the annular opening 103 of the nut 10 is expanded outward, the flat tubular portion of the annular portion 102 is shortened, so that the axial movable space of the washer 11 is shortened.

Referring to FIG. 2 with reference to FIG. 1, the washer 14 has a central hole 141 which has a peripheral wall provided with a tapered face 15. The washer 14 has a side provided with a plurality of wedge-shaped teeth 16. Thus, the tapered face 15 of the washer 14 will not be locked by the annular opening 103 of the nut 10, so that the washer 11 is not locked and can be rotated freely. Each of the wedge-shaped teeth 16 of the washer 14 is a spatial inclined face with a thickness variation. Thus, by provision of the tapered face 15, the minimum diameter of the central hole 141 is located at the thickest portion of each of the wedge-shaped teeth 16, so that only the thickest portion of each of the wedge-shaped teeth 16 has a determined axial restriction effect as indicated by the phantom circles. However, when the relative angle between the annular opening 103 of the nut 10 and the washer 14 is deflected slightly, the annular opening 103 of the nut 10 is easily passed through the connection between the wedge-shaped teeth 16 of the washer 14 and is detached from the washer 14, so that the nut 10 will be detached from the washer 14.

### BRIEF SUMMARY OF THE INVENTION

In accordance with the present invention, there is provided a self-locking nut assembly, comprising a nut, and a washer connected with the nut. The nut has a screw bore. The nut has a bottom provided with a first wedge-shaped portion. The first wedge-shaped portion of the nut includes at least one oneway wedge-shaped tooth. The washer has a central portion provided with a conical hole. The washer has a top provided with a second wedge-shaped portion having a shape matching that of the first wedge-shaped portion of the nut. The washer has a bottom provided with a plurality of protruding bars which are arranged in a radiating manner. The nut has a periphery provided with a protruding conical ring located between the first wedge-shaped portion and the screw bore. The conical hole of the washer includes a limit section and an annular tapered section. The limit section of the conical hole has a diameter slightly greater than an outer diameter of the conical ring of the nut. The second wedge-shaped portion of the washer has at least one oneway wedge-shaped tooth. The limit section of the conical hole extends from a bottom of the oneway wedge-shaped tooth of the second wedge-shaped portion toward the bottom of the washer, and has a determined thickness. The annular tapered section of the conical hole is inclined relative to and extended outward from the limit section and has a tapered angle relative to an axis of center of the conical hole. The conical ring of the nut is extended through the conical hole of the washer. The conical ring of the nut has a distal portion provided with an annular opening. The annular opening of the conical ring has a periphery provided with a protruding flange. The annular opening of the conical ring is enlarged and expanded outward to form the protruding flange. The protruding flange of the conical ring has a size greater than a diameter of the conical hole of the washer. The protruding flange of the conical ring is limited by the limit section of the conical hole.

The washer has a circular shape. Alternatively, the washer has a hexagonal shape. The thickness of the limit section has an optimum value ranged between 0.1 mm and 0.3 mm. The tapered angle of the annular tapered section has an optimum value ranged between 25° and 35°. The conical ring of the nut has a constant outer diameter. The conical ring of the nut has a root portion whose thickness is greater than that of the annular opening. The outer diameter of the protruding flange is disposed at a vertical state. The conical ring has an upright and flat outer portion under the protruding flange.

The primary objective of the present invention is to provide a self-locking nut assembly whose nut and washer will not interfere with each other.

According to the primary advantage of the present invention, a determined clearance is defined between the conical ring of the nut and the conical hole of the washer, so that the nut and the washer have determined axial and radial gaps, and the washer can be rotated freely.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional assembly view of a conventional self-locking nut assembly in accordance with the prior art.

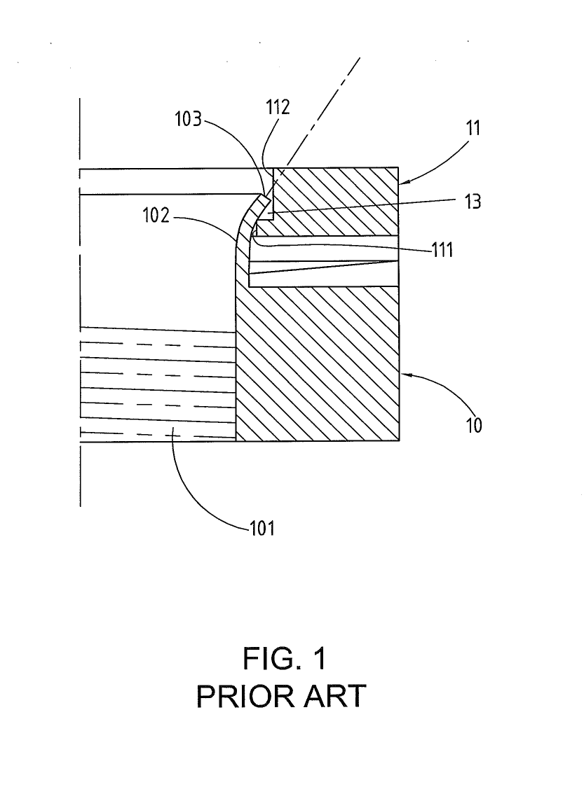

FIG. 2 is a partially perspective cross-sectional view of a washer of another conventional self-locking nut assembly in accordance with the prior art.

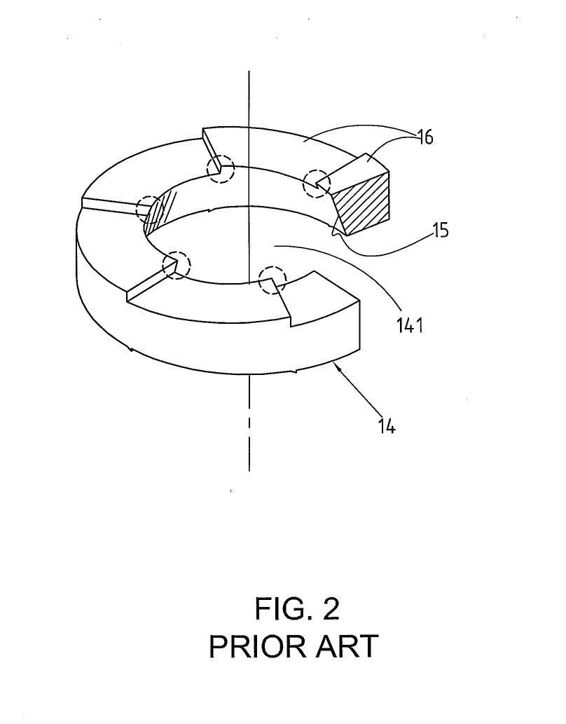

FIG. 3 is an exploded perspective view of a self-locking nut assembly in accordance with the preferred embodiment of the present invention.

FIG. 4 is a front cross-sectional assembly view of the self-locking nut assembly as shown in FIG. 1.

### DETAILED DESCRIPTION OF THE INVENTION

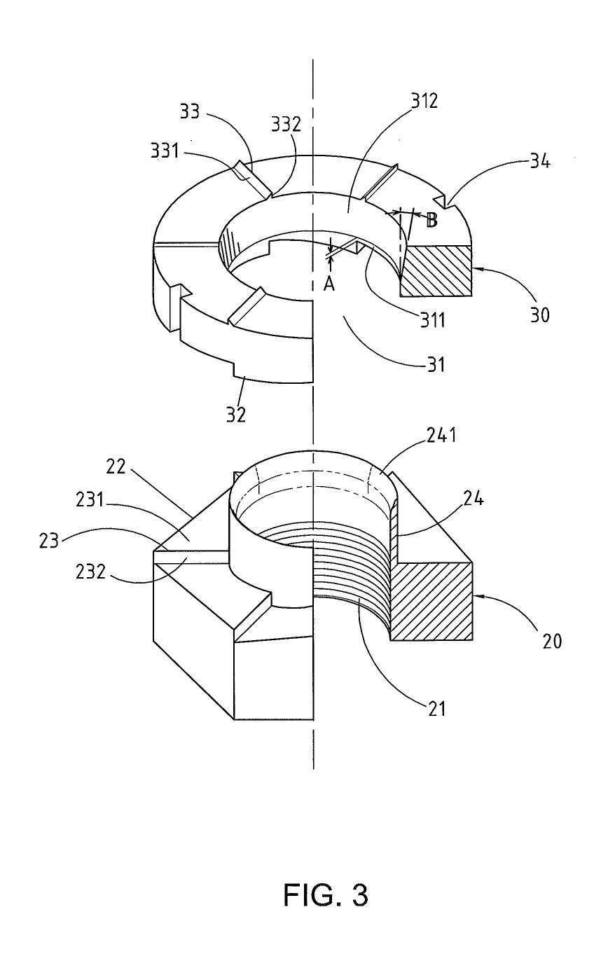

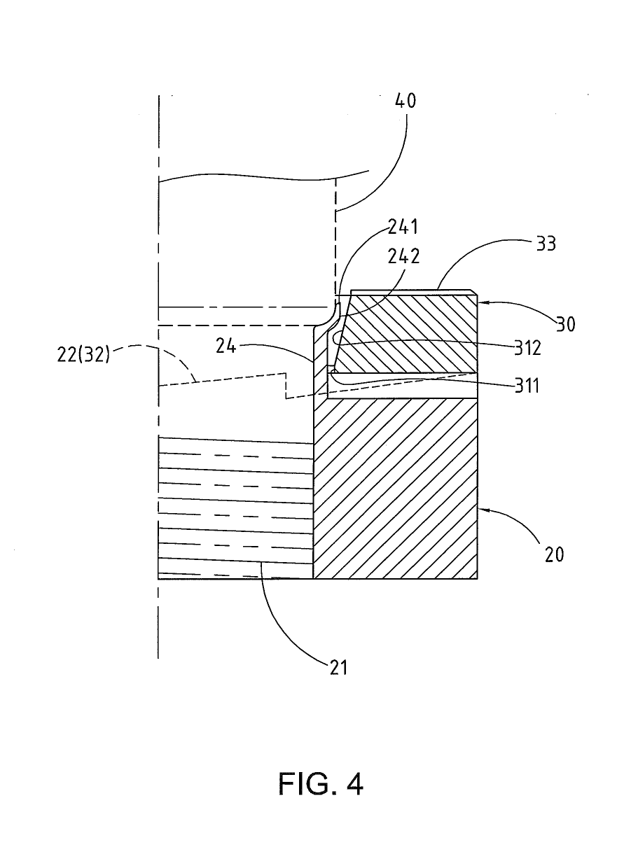

Referring to FIGS. 3 and 4, a self-locking nut assembly in accordance with the preferred embodiment of the present invention comprises a nut 20, and a washer 30 connected with the nut 20.

The nut 20 has a hexagonal shape and has a central portion provided with a screw bore 21. The nut 20 has a bottom provided with a first wedge-shaped portion 22. The first wedge-shaped portion 22 of the nut 20 includes at least one oneway wedge-shaped tooth 23. The oneway wedge-shaped tooth 23 of the first wedge-shaped portion 22 includes a ramp 231 and a vertical catch face 232. The ramp 231 of the oneway wedge-shaped tooth 23 has an outer edge and an inner edge. The outer edge and the inner edge of the ramp 231 have the same height at the same central angle. The nut 20 has a periphery provided with a protruding conical ring 24 located between the first wedge-shaped portion 22 and the screw bore 21. The conical ring 24 of the nut 20 has a cross-sectional profile with the same outer diameter. The conical ring 24 of the nut 20 has a distal portion provided with an annular opening 241. The conical ring 24 of the nut 20 has an inner conical shape and has a root portion whose thickness is greater than that of the annular opening 241. The annular opening 241 of the conical ring 24 has a periphery provided with a protruding flange 242.

The washer 30 has a top provided with a second wedge-shaped portion 32 having a shape matching that of the first wedge-shaped portion 22 of the nut 20. The washer 30 has a bottom provided with a plurality of protruding bars 33 which are arranged in a radiating manner. Each of the protruding bars 33 of the washer 30 includes an oblique wall 331 and a vertical wall 332. The oblique wall 331 of each of the protruding bars 33 is arranged in a screwing direction of the nut 20. The washer 30 has a central portion provided with a conical hole 31. The conical hole 31 of the washer 30 includes a limit section 311 and an annular tapered section 312. The limit section 311 of the conical hole 31 has a diameter slightly greater than an outer diameter of the conical ring 24 of the nut 20 as shown in FIG. 4. The second wedge-shaped portion 32 of the washer 30 has at least one oneway wedge-shaped tooth. The limit section 311 of the conical hole 31 extends from a bottom of the oneway wedge-shaped tooth of the second wedge-shaped portion 32 toward the bottom of the washer 30, and has a determined thickness “A”. The annular tapered section 312 of the conical hole 31 is inclined relative to and extended outward from the limit section 311 and has a tapered angle “B” relative to an axis of center of the conical hole 31. Preferably, the thickness “A” of the limit section 311 has an optimum value ranged between 0.1 mm and 0.3 mm, and the tapered angle “B” of the annular tapered section 312 has an optimum value ranged between 25° and 35°, so that the nut 20 and the washer 30 are connected in an optimum manner. The washer 30 has a circular shape and has an outer periphery provided with at least one slot 34 to allow insertion of a special tool. Alternatively, the washer 30 has a hexagonal shape for operation of a normal hand tool.

In fabrication, the conical ring 24 of the nut 20 is extended through the conical hole 31 of the washer 30. Then, a plunger 40 of a stamping die is inserted into the annular opening 241 of the conical ring 24 to enlarge the annular opening 241 of the conical ring 24 so as to form the protruding flange 242. At this time, the annular opening 241 of the conical ring 24 has a determined thickness smaller than that of the root of the conical ring 24, so that the annular opening 241 of the conical ring 24 is easily expanded outward to form the protruding flange 242. In such a manner, the protruding flange 242 of the conical ring 24 has a size greater than a diameter of the conical hole 31 of the washer 30, so that the protruding flange 242 of the conical ring 24 is limited by the limit section 311 of the conical hole 31. Thus, the nut 20 and the washer 30 are combined together and will not be detached from each other.

Especially, the annular opening 241 of the conical ring 24 has a determined thickness smaller than that of the root of the conical ring 24, so that the angle of the outer diameter of the protruding flange 242 can be contracted inward, and the outer diameter of the protruding flange 242 is disposed at a vertical state. In addition, the outer diameter of the conical ring 24 will not be expanded outward and enlarged so that the conical ring 24 has an upright and flat outer portion under the protruding flange 242. Thus, a determined clearance is defined between the conical ring 24 of the nut 20, and the limit section 311 and the annular tapered section 312 of the washer 30, so that after the nut 20 and the washer 30 are combined together, the nut 20 and the washer 30 have determined axial and radial gaps, and the washer 30 can be rotated freely.

Accordingly, a determined clearance is defined between the conical ring 24 of the nut 20 and the conical hole 31 of the washer 30, so that the nut 20 and the washer 30 have determined axial and radial gaps, and the washer 30 can be rotated freely.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A self-locking nut assembly, comprising:
a nut; and
a washer connected with the nut; wherein:
the nut has a screw bore;
the nut has a bottom provided with a first wedge-shaped portion;
the first wedge-shaped portion of the nut includes at least one oneway wedge-shaped tooth;
the washer has a central portion provided with a conical hole;
the washer has a top provided with a second wedge-shaped portion having a shape matching that of the first wedge-shaped portion of the nut;
the washer has a bottom provided with a plurality of protruding bars which are arranged in a radiating manner;
the nut has a periphery provided with a protruding conical ring located between the first wedge-shaped portion and the screw bore;
the conical hole of the washer includes a limit section and an annular tapered section;
the limit section of the conical hole has a diameter slightly greater than an outer diameter of the conical ring of the nut;
the second wedge-shaped portion of the washer has at least one oneway wedge-shaped tooth;
the limit section of the conical hole extends from a bottom of the oneway wedge-shaped tooth of the second wedge-shaped portion toward the bottom of the washer, and has a determined thickness;
the annular tapered section of the conical hole is inclined relative to and extended outward from the limit section and has a tapered angle relative to an axis of center of the conical hole;
the conical ring of the nut is extended through the conical hole of the washer;
the conical ring of the nut has a distal portion provided with an annular opening;
the annular opening of the conical ring has a periphery provided with a protruding flange;
the annular opening of the conical ring is enlarged and expanded outward to form the protruding flange;
the protruding flange of the conical ring has a size greater than a diameter of the conical hole of the washer; and
the protruding flange of the conical ring is limited by the limit section of the conical hole.

2. The self-locking nut assembly of claim 1, wherein the washer has a circular shape.

3. The self-locking nut assembly of claim 1, wherein the washer has a hexagonal shape.

4. The self-locking nut assembly of claim 1, wherein the thickness of the limit section has an optimum value ranged between 0.1 mm and 0.3 mm.

5. The self-locking nut assembly of claim 1, wherein the tapered angle of the annular tapered section has an optimum value ranged between 25° and 35°.

6. The self-locking nut assembly of claim 1, wherein:
the conical ring of the nut has a constant outer diameter; and
the conical ring of the nut has a root portion whose thickness is greater than that of the annular opening.

7. The self-locking nut assembly of claim 1, wherein:
the outer diameter of the protruding flange is disposed at a vertical state; and
the conical ring has an upright and flat outer portion under the protruding flange.
